(19) United States
(12) Patent Application Publication
(10) Pub. No.: US 2011/0304296 A1
(43) Pub. Date: Dec. 15, 2011

(54) Light-Powered Transmitter Assembly

(75) Inventor: Roger F. Buelow, II, Gates Mills, OH (US)

(73) Assignee: Energy Focus, Inc., Solon, OH (US)

(21) Appl. No.: 13/157,025

(22) Filed: Jun. 9, 2011

Related U.S. Application Data
(60) Provisional application No. 61/353,007, filed on Jun. 9, 2010.

(51) Int. Cl. H01M 10/46

(52) U.S. Cl. 320/101

(57) ABSTRACT

Disclosed is a light-powered transmitter assembly for transmitting a wireless signal relating to received light. The assembly comprises a photovoltaic device and an energy storage device connected to the photovoltaic device for receiving charge from the photovoltaic device. A threshold charge-sensing circuit connects to the energy storage device for making a determination whenever the charge of the energy storage device reaches a threshold level. A transmitting circuit, responsive to the threshold charge-sensing circuit, transmits a wireless signal that is indicative of the energy storage device having reached the threshold level of charge and that uniquely identifies the wireless signal as corning from the light-powered transmitter assembly. The transmitting circuit is at least partially powered from energy received from the energy storage device. An interval between two successive ones of the determinations is a function of average intensity of light received by the photovoltaic device.

### CROSS-REFERENCE TO RELATED APPLICATIONS

This application claims priority from U.S. Provisional Application No. 61/353,007, filed on Jun. 9, 2010, the disclosure of which is incorporated herein by reference in its entirety.

### FIELD OF THE INVENTION

The present invention relates to a light-powered assembly for wirelessly transmitting information relating to received light.

### BACKGROUND OF THE INVENTION

Energy used by lighting systems constitutes a majority of energy consumption in a given environment. The traditional wired lighting systems are not able to regulate the amount of light distributed from light sources in response to changing needs, such as all persons leaving a hallway, light output diminishing from an aging light source, changes in natural light received in a given environment, or in accordance with specific lighting regulations that may vary depending on location and application. For instance, when natural light enters in the given environment, the wired lighting system is unable to adjust the intensity of the lighting in the environment to account for the natural light received. Dimmers have been added to such lighting systems. However, the dimmers need to be operated manually.

Methods and systems for providing light intensity data to a lighting system are known to those skilled in the art. For example, wireless communication has been used to transmit data regarding the intensity of lighting in a room through remote light intensity sensors. Another example of transmitting a signal wirelessly to a lighting system is an automatic timer. These devices provide data to the lighting system to allow the lighting system to adjust the intensity of the lighting according to the time of day. Other lighting systems exist that use light intensity sensors, of either the wireless or wired type that transmit light intensity data to a lighting control system.

The advantage of a wireless remote sensing system is the ability to transmit data regarding the lighting from anywhere wherein the remote sensing signal can reach the lighting control system. However, there are several drawbacks with currently available systems. These devices are typically bulky, expensive and are difficult to use in large illuminated areas due in part to the expense of using several sensors. This problem typically becomes multiplied, because wireless remote sensors must be placed in multiple, specific locations. Many remote sensors of the wired type use the associated building power as an energy source. Therefore, the wired type remote sensors need to be located near an outlet or a point where it can be wired into the existing building power distribution system, and also must be located in the light-distribution range of the lighting system. Another problem with wired type remote sensors are that the sensors do not have sustainable energy. The energy source is typically a building power outlet or a battery. Batteries do not provide a sustainable energy source in which the light sensing device can operate on, and thus provide a limited period of time during which they are functional. The maintenance of battery-powered light sensors can also be time-consuming and costly.

There is a need for a device that can monitor light intensity in a given environment and provide data to a lighting system, and that has the flexibility of wireless communication capabilities to transmit data to a lighting system in response to changes in the amount of light being received in the environment. This device should also incorporate a sustainable energy source to overcome the disadvantages stated above.

### BRIEF SUMMARY OF THE INVENTION

A preferred form of the invention provides a light-powered transmitter assembly for transmitting a wireless signal relating to received light. The assembly comprises a photovoltaic device and an energy storage device connected to the photovoltaic device for receiving charge from the photovoltaic device. A threshold charge-sensing circuit connects to the energy storage device for making a determination whenever the charge of the energy storage device reaches a threshold level. A transmitting circuit, responsive to the threshold charge-sensing circuit, transmits a wireless signal that is indicative of the energy storage device having reached the threshold level of charge and that uniquely identifies the wireless signal as coming from the light-powered transmitter assembly. The transmitting circuit is at least partially powered from energy received from the energy storage device. An interval between two successive ones of the determinations is a function of average intensity of light received by the photovoltaic device.

Beneficially, the foregoing light-powered transmitter assembly can wirelessly monitor light intensity in a given environment and provide data to a lighting system. Other object and advantages of the invention will be set forth below.

### BRIEF DESCRIPTION OF THE DRAWINGS

For further understanding of the advantages of the present invention, reference should be made to the following description taken in conjunction with the accompanying drawings, in which like reference numbers refer to like parts.

FIG. 1 is a block diagram of a light-powered transmitter assembly made in accordance with the present invention, together with artificial and natural lighting sources and a lighting control system having a receiver

FIG. 2 is a block diagram showing the light-powered transmitter assembly of FIG. 1 in more detail than in FIG. 1.

FIG. 3 are timing diagrams of various transmission alternatives in relation to “determinations” made.

FIG. 4 is a block diagram of a modified photovoltaic device for use in the light-powered transmitter assembly of FIG. 1 or 2.

FIG. 5 is a flow chart of preferred steps for using a light-powered transmitter assembly according to the present invention.

FIG. 6 is a top plan view of a light-powered transmitter assembly in accordance with the invention.

FIG. 7 is a cross-sectional view of FIG. 6 taken at lines 7-7 in FIG. 6.

FIG. 8 is an enlarged view of the circled area in FIG. 7 marked as “FIG. 8.”

FIGS. 9 and 10 are cross-sectional views of FIG. 6 taken at lines 9-9 and 10-10 in FIG. 6, respectively.

### DETAILED DESCRIPTION OF THE PREFERRED EMBODIMENT

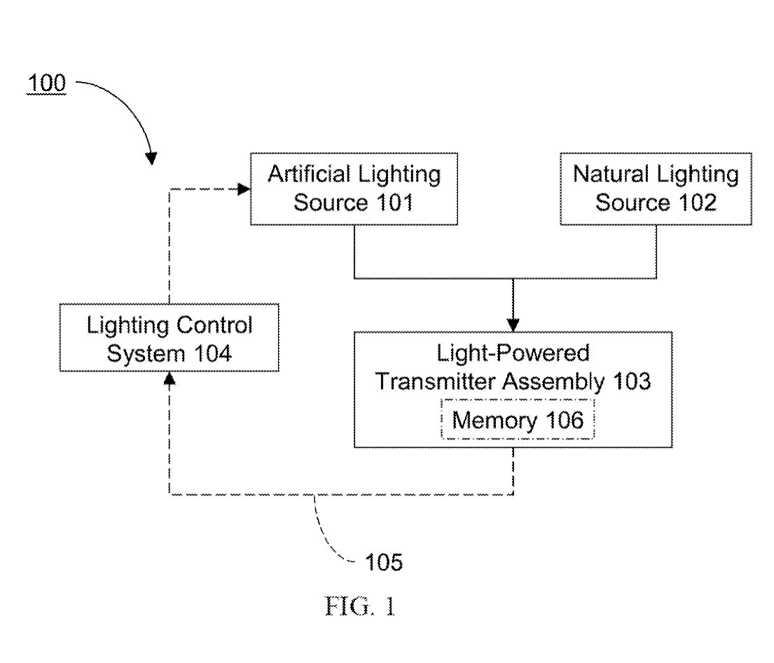

FIG. 1 shows a lighting system 100, which has one or more light-powered transmitter assemblies 103 in accordance with the present invention. A lighting system 100 will typically use multiple light-powered transmitter assemblies 103, but for simplicity in this description reference will usually be made to only one of such assemblies 103. Lighting system 100 includes an artificial lighting source 101, which can be one or more lamps, lighting fixtures, ballasts, or any other artificial lights, and may include a natural lighting source 102. The light-powered transmitter assembly 103 monitors the lighting level in a given environment and transmits data regarding the lighting level of the environment to a lighting control system 104. The lighting control system 104 can control the artificial lighting source 101. The light-powered transmitter assembly 103 receives light from both the artificial lighting source 101 and from any natural lighting source 102 that is present. The light-powered transmitter assembly 103 relays a signal, as indicated by dashed-line 105, on the basis of the amount of light it receives from the artificial and natural sources of light. Part of the signal also uniquely identifies the specific light-powered transmitter assembly 103 which transmits the signal. The relaying of the signal indicated by dashed-line 105 provides to lighting control system 104 data regarding the amount of light being received in a given environment. The lighting control system 104 can then use the data for purposes such as adjusting the intensity of the artificial light sources relative to the amount of natural lighting received in the environment. For example, if the natural lighting increases the amount of light in the environment beyond a predetermined threshold level, the lighting control system 104 will decrease the lighting received from artificial source of light in response to one or more signals from the light-powered transmitter assembly 103. In this way, the intensity of lighting in an environment can remain constant, while saving energy by decreasing the amount of energy used by the artificial light source.

### One Transmission for Every “Determination”

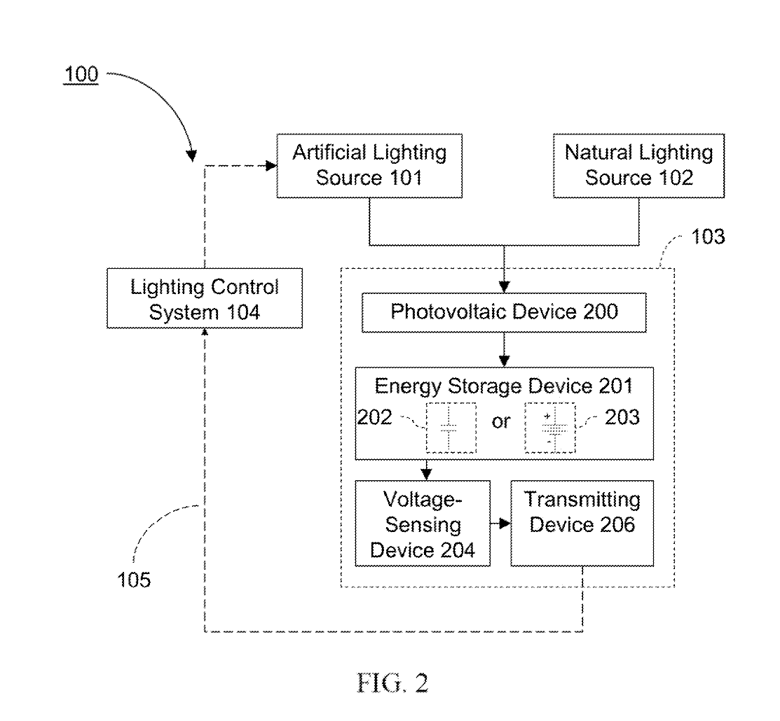

FIG. 2 shows the lighting system 100 of FIG. 1, with more details of the light-powered transmitter assembly 103. FIG. 2 helps explain the wireless signal transmitting capabilities of the light-powered transmitter assembly 103. The light-powered transmitter assembly 103 can receive light from either the artificial lighting source 101 or the natural lighting source 102 or from both of these sources 101 and 102, so long as they can deliver measurable light to the transmitter assembly 103. In assembly 103, this light is received by the photovoltaic device 200. The photovoltaic device 200 harnesses energy from the artificial lighting source 101 and the natural lighting source 102. This energy is stored in the energy storage device 201, which may be a capacitor 202 or a battery 203, such as a silk-screen printable battery made from zinc-manganese. The charge of the energy storage device 201 is monitored by a charge-sensing device 204; for capacitor 202, charge is typically determined by the voltage across the capacitor. In one embodiment of the present invention, the charge-sensing device 204 is an integrated circuit or part of an integrated circuit assembly. The charge-sensing device 204 gauges the charge of the energy storage device, and when it senses that the energy storage device has reached a maximum, threshold charge level, referred to herein as a “determination,” the energy storage device discharges until the charge of the energy storage device reaches a second, lower charge threshold. The energy storage device 201 then recharges with energy generated by the photovoltaic device 200, and discharges periodically at a rate determined by the amount of incident light received by the photovoltaic device 200.

The discharged energy from the energy storage device 201 travels to a transmitting device 206, such as any of a solid state transponder, a solid state transmitter, a solid state transreceiver, or an integrated circuit. In response to receiving the discharged energy from the energy storage device 201, the transmitting device 206 relays a wireless signal to the lighting control system 104 for controlling the artificial lighting source 101. However, a single wireless signal alone will not indicate the average level of light received by the photovoltaic device 200. Rather, it is an interval of time between a pair of successive determinations, as that term is used earlier in this paragraph, which provides an indication of an averaged amount of light received by the light-powered transmitter assembly 103 between such successive determinations. By way of example, when the combination of light from artificial and natural lighting sources 101 and 102 in an environment decreases, the transmitting device 206 of a light-powered transmission assembly 103 transmits wireless signals with longer intervals between successive transmissions to the lighting control system 104. The lighting control system 104 then, using algorithms, determines the required change in lighting level from the artificial lighting source 101 needed and adjusts the artificial lighting source 101 so as to maintain a constant light intensity in a given environment from both artificial and natural lighting sources in the subject example.

The transmitting device 206 is preferably powered, at least partially, by the energy received from the energy storage device 200 upon discharging of device 200 as described in the foregoing paragraph. More preferably, the transmitting device 206 is fully powered from the energy received from the energy storage device 200 upon discharging of device 200 as described in the foregoing paragraph.

### One Transmission for Multiple “Determinations”

Also referring mainly to FIG. 2, in another embodiment of the present invention, the transmitting device 206 does not transmit a wireless signal to the lighting control system 104 every time a “determination” has been made. Rather, the light-powered transmitter assembly 103, as shown in FIG. 1, includes a memory 106 for storing data relating to one or more intervals between successive “determinations,” as defined above. For example, the data in memory 106 may represent time intervals of, for instance, 10 seconds, 15 seconds, etc. Alternatively, it could simply store the times of each determination, such as 2:07:10 pm, 2:08:25 pm, etc. The transmitting device 206 then is configured to transmit one wireless signal to the lighting control system 104 after a plurality of such “determinations” has been made. Circuitry in the lighting control system 104 then considers the data received, representing one or more intervals between successive “determinations,” so as to assess an averaged light level received by the light-powered transmitter assembly 104. Responsively, for instance, the lighting control system 104 can change the light output of the artificial lighting source 101 based on the received data.

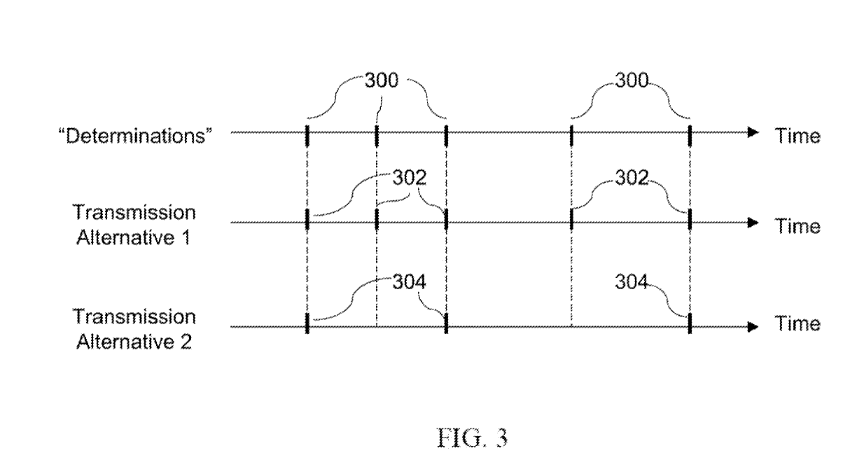

The timing diagrams of FIG. 3 compare the foregoing alternatives of one transmission for each “determination,” and one transmission for multiple determinations. These alternatives are noted as transmission alternatives 1 and 2, respectively in FIG. 3. Regarding transmission alternative 1, for each determination 300 made, there is shown one transmission 302 from transmitting device 206. Regarding transmission alternative 2, for every multiple (e.g., two) determinations 300 made, there is shown one transmission 304 from transmitting device 206.

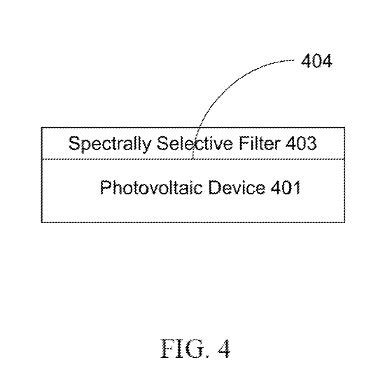

FIG. 4 shows a modified photovoltaic device 401 for use in the light-powered transmitter assembly 103 of FIG. 2, for instance. The modified device 401 has a spectrally selective filter 403 overlying an active surface 404 of the photovoltaic device 401 that receives light for photovoltaic conversion. The spectrally selective filter 403 can be a colored gel film, a dye in a plastic lens, a dichroic filter, or paint, by way of example. The spectrally selective filter 403 is typically used to either selectively pass or, conversely, to selectively block light in a specified range of wavelengths. In one embodiment of the present invention, the spectrally selective filter is a glass or plastic window. This filtering is usually effected by passing the light through the filter 403 that has been specially treated to transmit, absorb or reflect light in some wavelengths. Two exemplary uses for such a filter 403 are as follows.

One example of a spectrally selective filter 403 concerns the ability to provide a measure of relatively high red content natural lighting in an environment that also has relatively low red content fluorescent lighting. In this case, the filter 403 would pass light with red content while not allowing light of other colors to pass. The light-powered transmitter assembly 103 of FIG. 2 would then make “determinations” based on the content of red lighting impinging on the photovoltaic device 401. Accordingly, in an environment with partial relatively higher red content natural lighting and partial relatively low red content fluorescent lighting, relative comparisons of natural and artificial lighting can be determined.

Another example of a spectrally selective filter 403 concerns the use of infrared light in an infrared light security system, in which a camera can “see” objects in a surveilled area that are lighted by the infrared light. As is known, infrared light is not visible to the naked eye. To assure that the object is sufficiently illuminated with infrared light so that the camera can obtain a clear image of an object, the light-powered transmitter assembly 103 of FIG. 2 can use a filter 403 that selectively passes infrared light. Assembly 103 then would make “determinations” in relation to the average intensity of infrared light being received, which data can be used to make sure that the infrared light sources are controlled to provide adequate lighting so that the camera can obtain clear images of an object in the surveilled area.

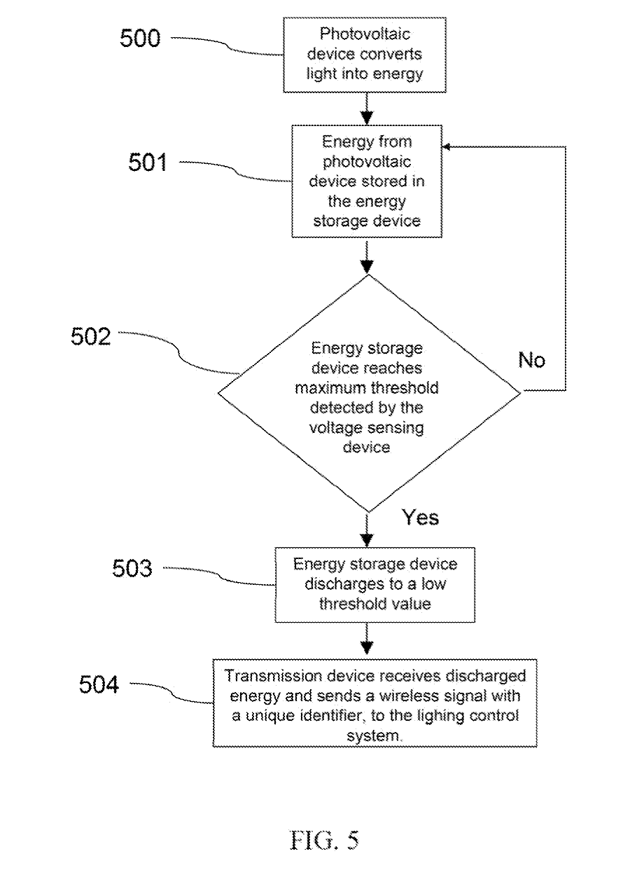

FIG. 5 is a flow chart for the steps of working of the light-powered transmitter assembly 104. The method starts at step 500, wherein the photovoltaic device converts received light into energy. In step 501, the energy from the photovoltaic device is stored in the energy storage device. According to step 502, a “determination,” as defined above, is as to whether the energy storage device has reached a maximum threshold. This may be done by using a charge-sensing device 204 as described above. If the determination is “yes,” then as shown in step 503, the energy storage device discharges its stored energy until the voltage of that device reaches a predetermined, low threshold value. In step 504, the discharge of energy according to step 503 causes a transmitting device to send a wireless signal to the lighting control system 104 indicating that a “determination” has been made. The lighting control system 104 can then adjust the level of light in artificial lighting source 101 if necessary, by way of example. Once the energy storage device discharges, according to step 503, which is typically in a fraction of a second, then, according to step 501, the energy storage device again begins storing energy derived from the photovoltaic device. Typically, a photovoltaic device continues to supply a minute and thus negligible amount of charge to the energy storage device while the energy storage device is being discharged. If the determination from step 502 is “no,” then as shown in step 501, energy continues to be stored in the energy storage device.

Another embodiment is a light-powered transmitter assembly with more than one photovoltaic device, such as two photovoltaic devices with non-identical bandgaps, and a respective energy storage device, charge-sensing device and transmitting device, for each photovoltaic device. Where two photovoltaic devices in the same transmitter assembly have non-identical bandgaps, their respective transmitting devices each needs to transmit a unique identifier in its wireless signal. Thus, the single light-powered transmitter assembly essentially comprises a pair of respective light-powered transmitter assemblies for simultaneous measuring of light received from two different portions of the electromagnetic spectrum.

### Preferred Physical Form of Light-Powered Transmitter Assembly

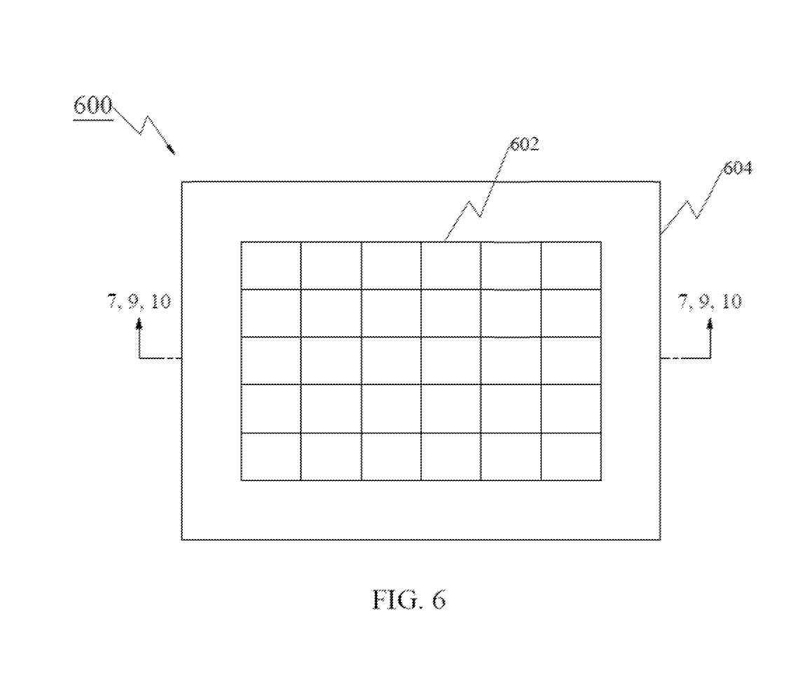

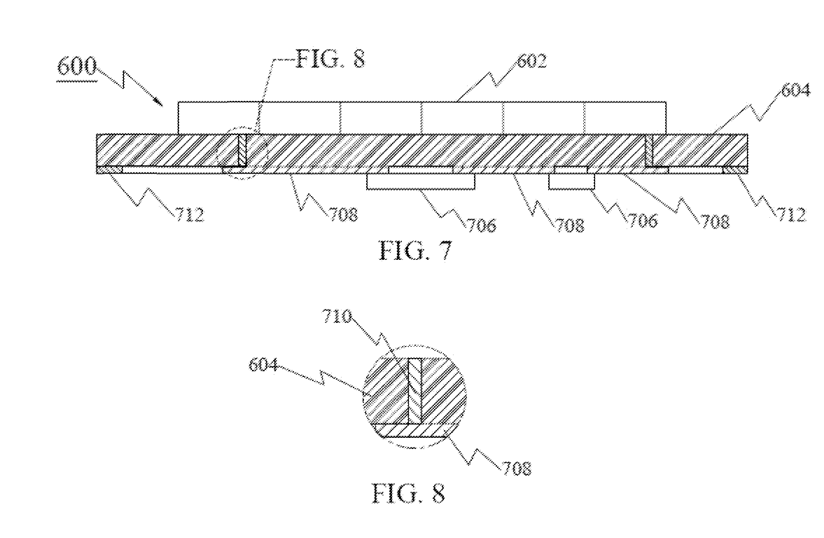

FIGS. 6-8 illustrate an example of a preferred physical form of a light-powered transmitter assembly 600. As shown in these figures (e.g., FIGS. 6 and 7), a photovoltaic device array 602 is mounted on one major side of a preferably flexible substrate 604. Flexible substrate may comprise KAPTON-brand polyimide film, which is available from E. I. Du Pont De Nemours and Company of Wilmington, Del., USA, by way of example. Various electrical components 706, which preferably include a threshold charge-sensing device (e.g., 204, FIG. 2) and a transmitting device (e.g., 206, FIG. 2) are mounted on another—i.e., lower-shown—major side of the substrate 604. As shown in the enlarged view of FIG. 7, conductors 708, which penetrate through the substrate 604, connect the photovoltaic device array 602 with the electrical components 706 on the opposite side of substrate 604. Other conductors 710 interconnect and typically underlie various electrical components 706. An antenna 712 for the mentioned transmitting device preferably is formed near the periphery of the thin edge of substrate 604, which can help maximize the length of the antenna when making a single, large loop around the periphery of the substrate. Other antenna configurations are possible, as well, including having the antenna underlying the electrical components 706 as viewed in FIG. 7, for instance.

FIG. 8 shows other conductor 710, which interconnects the photovoltaic device array 602 on one side of substrate 604 with circuitry 706 and 708 on the other side of the substrate 604.

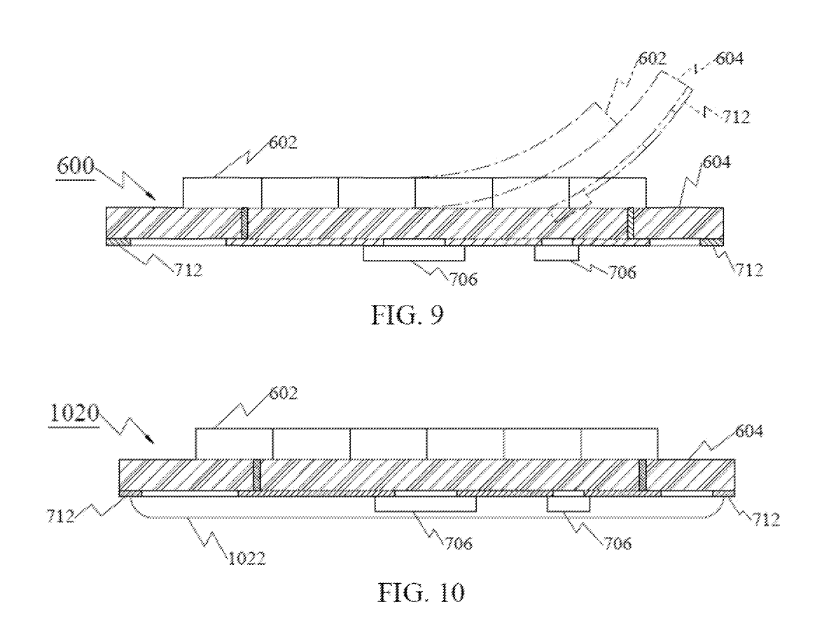

FIG. 9 illustrates a preferred, flexible characteristic of substrate 604 and preferably also of photovoltaic device array 602. The electrical components 706 may or may not be flexible as well. In particular, the right-hand ends of substrate 604 and of photovoltaic device array 602 are shown in phantom lines as being bent upwardly.

FIG. 10 shows a modified light-powered transmitter assembly 1020, which differs from light-powered transmitter assembly 600 of FIGS. 6-9 by including an adhesive layer 1022 that preferably covers a majority of the lower-shown surface area of assembly 1020. More preferably, adhesive layer 1022 covers at least about 70 percent of the lower-shown surface area of assembly 1020, and more preferably covers at least about 90 percent of the lower-shown surface area of assembly 1020. Adhesive layer 1022 may be a pressure-sensitive adhesive, and alternative fastening means include hook and loop fasteners and a flexible magnetic layer. The foregoing types of fastening means work especially well with a flexible substrate 604, since the installer can easily press a thumb, for instance, against all of the upper-shown surface of the light-powered transmitter assembly 1020 to assure sturdy attachment to a wall, desk, ceiling or floor, for example.

Other types of fastening means includes a nail or screw which passes through a hole (not shown) in the substrate 604, which can be of the non-flexible type.

The embodiments described herein are exemplary only, and are not intended to be limiting. Many variations and modifications of the disclosure disclosed herein are possible and are within the scope of the disclosure. Where numerical ranges or limitations are expressly stated, such express ranges or limitations should be understood to include iterative ranges or limitations of like magnitude falling within the expressly stated ranges or limitations. Use of broader terms such as “comprises,” “includes,” “having,” etc. should be understood to provide support for narrower terms such as consisting of, consisting essentially of, comprised substantially of, etc.

What is claimed is:

1. A light-powered transmitter assembly for transmitting a wireless signal relating to received light, said assembly comprising:
a) a photovoltaic device;
b) an energy storage device connected to the photovoltaic device for receiving charge from the photovoltaic device;
c) a threshold charge-sensing circuit connected to the energy storage device for making a determination whenever the charge of the energy storage device reaches a maximum threshold level;
d) a transmitting circuit, responsive to the threshold charge-sensing circuit, for transmitting a wireless signal that is indicative of the energy storage device having reached said maximum threshold level of charge and that uniquely identifies the wireless signal as coming from said light-powered transmitter assembly; said transmitting circuit being at least partially powered from energy received from the energy storage device; and
e) an interval between two successive ones of said determinations is a function of average intensity of light received by the photovoltaic device.

2. The assembly of claim 1, wherein the energy storage device is a capacitor.

3. The assembly of claim 1, wherein the energy storage device is a battery.

4. The assembly of claim 1, wherein the transmitting circuit is fully powered by energy received from the energy storage device.

5. The assembly of claim 1, wherein the transmitting circuit transmits one wireless signal indicating that a determination has been made by the threshold charge-sensing circuit a predetermined time after each said determination.

6. The assembly of claim 1, further comprising:
a) a memory for storing data relating to one or more intervals between successive determinations made by the threshold charge-sensing circuit; and
b) the transmitting circuit being configured to transmit one wireless signal each time after a plurality of said intervals of time has elapsed.

7. The assembly of claim 1, wherein the transmitting circuit is a solid state transponder, or a solid state transmitter, or a solid state transreceiver, or an integrated circuit.

8. The assembly of claim 1, wherein the charge-sensing device is a solid state transponder, or a solid state transreceiver, or an integrated circuit.

9. The assembly of claim 1, wherein the photovoltaic device is mounted on one major side of a flexible substrate, and the at least one threshold charge-sensing circuit, and the transmitting circuit are mounted on another major side of the flexible substrate.

10. The assembly of claim 9, wherein the transmitting circuit has an antenna formed on said another major side of the flexible substrate and surrounding the at least one threshold charge-sensing circuit and the transmitting circuit.

11. The assembly of claim 9, wherein the flexible substrate is provided with an adhering means covering more than about 70 percent of the surface of one side of the flexible substrate for attachment to a mounting surface.

12. The assembly of claim 1, wherein the adhering means is a pressure sensitive adhesive or hook and loop fasteners, or a magnetic means.

13. The assembly of claim 1, further comprising a spectrally selective filter for filtering light received by the photovoltaic device.

14. The assembly of claim 13 wherein the spectrally selective filter is a colored gel film, a dye in a plastic lens, a dichroic filter, or paint.
